(19) United States
(12) Patent Application Publication
(10) Pub. No.: US 2010/0188042 A1
(43) Pub. Date: Jul. 29, 2010

(54) Electrical power transmission apparatus

(76) Inventor: Ming-Hsiang Yeh, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/320,542

(22) Filed: Jan. 29, 2009

(51) Int. Cl. H02J 7/00

(52) U.S. Cl. 320/109

(57) ABSTRACT

The electrical power transmission apparatus is electrically connected to an electrical main and a fee collecting device. The electrical power transmission apparatus includes a transmission unit that includes a first output port and a second output port; an electrical power flow detector is electrically connected to the electric main; a conversion unit includes a first converter and a second converter that effect conversion of electrical power, the first and second converters are respectively and electrically connected between the first and second output ports and the electrical power flow detector, and the first and second output ports respectively supply alternate-current (AC) power and direct-current (DC) power through the conversion effected by the first and second converters; and a processing unit is electrically connected between the electrical power flow detector and the fee collecting device and is further electrically connected to the conversion unit to control selection of the electrical power to be transmitted to AC power or DC power. The processing unit receives a detection result of the electrical power flow detected by the electrical power flow detector for generating a related amount of fee with which the fee collecting device carries out a fee collecting operation.

### FIELD OF THE INVENTION

The present invention relates to an electrical power transmission apparatus, and in particular to an electrical power transmission apparatus that sells electrical power to all sorts of electricity-operated machines (such as an electrical automobile, an electrical motorcycle, a lawn mower, a lawn removing device, or an electrical saw) or storage battery removed from such electricity-operated machines and that additionally buys electrical power from an external source.

### BACKGROUND OF THE INVENTION

Since fossil resources provided by the Earth is limited and further due to the global warming issue that we are facing today, locomotive vehicle, such as cars and motorcycles, that are driven by fossil fuel operated engines will be gradually replaced by electrical automobiles and electrical motorcycles.

Although being environmentally friendly, the electrical automobiles and electrical motorcycles do not have a satisfactory duration of operation for each charge of power. Although the industry has been devoted to the development of high-capacity compact battery, facility for charging those batteries is also needed to provide convenient service of electricity charging in order to popularize the use of electrical automobile and electrical motorcycle.

Thus, the present invention aims to provide an electrical power transmission apparatus that functions to sell electrical power to all sorts of electricity-operated machines, including the electrical automobile and electrical motorcycle and the battery removed from such electricity-operated machines, and even to buy electrical power from an external source.

### SUMMARY OF THE INVENTION

An objective of the present invention is to provide an electrical power transmission apparatus, which is operated in substantially the same way as a gas station to sell electrical power from for example a electric main to the general consumers, such as a driver of an electrical automobile or an electrical motorcycle or an owner of a lawn mower, a lawn removing device, or an electrical saw, or a person who brings a battery removed from such electrical machines, so as to provide electricity charging service with the same convenience as a gas station for extending the duration of operation period of all sorts of electricity-operated machines.

Another objective of the present invention is to provide an electrical power transmission apparatus, which functions as a buying station that receives with proper payment external electrical power that is provided by a seller and sells the electrical power to a power company or a government agency, such as a seller transferring electrical power from a solar cell system to the electrical power transmission apparatus for further transmission through the network of an electric main to the power company or the government agency to realizing purchase of electrical power.

To realize the above objectives, the present invention provides an electrical power transmission apparatus, which is electrically connected to an electrical main and a fee collecting device. The electrical power transmission apparatus comprises a transmission unit, an electrical power flow detector, a conversion unit, and a processing unit.

The transmission unit comprises a first output port and a second output port. The electrical power flow detector serves to detect electrical power flow and the electrical power flow detector is electrically connected to the electric main. The conversion unit comprises a first converter and a second converter that effect conversion of electrical power. The first converter is electrically connected between the first output port and the electrical power flow detector. The second converter is electrically connected between the second output port and the electrical power flow detector. The first and second output ports respectively supply alternate-current (AC) power and direct-current (DC) power through the conversion effected by the first and second converters. The processing unit is electrically connected between the electrical power flow detector and the fee collecting device and the processing unit is further electrically connected to the conversion unit to control selection of the electrical power to be transmitted to AC power or DC power. The processing unit receives a detection result of the electrical power flow detected by the-electrical power-flow-detector for generating a related amount of-fee-with which the fee collecting device carries out a fee collecting operation

Another embodiment of the electrical power transmission apparatus comprises an automatic anode/cathode automatic switcher and a wireless receiving/transmitting device. The electrical power flow detector further comprises a current protection circuit.

A further embodiment of the electrical power transmission apparatus is additionally provided with the function of buying electrical power, wherein the transmission unit further comprise a first input port and a second input port and the conversion unit further comprises a third converter and a fourth converter that effect conversion of electrical power, and the electrical power transmission apparatus is further connected to a fee paying device.

### BRIEF DESCRIPTION OF THE DRAWINGS

The present invention will be apparent to those skilled in the art by reading the following description of preferred embodiments thereof with reference to the drawings, in which:

FIG. 1 is a schematic view illustrating selling electrical power to an electricity-operated machine in accordance with the present invention;

FIG. 2 is another schematic view illustrating selling electrical power to an electricity-operated machine in accordance with the present invention;

FIG. 3 is a block diagram of a first embodiment in accordance with the present invention;

FIG. 4 is a block diagram of a second embodiment in accordance with the present invention; and

FIG. 5 is a block diagram of a third embodiment in accordance with the present invention.

### DETAILED DESCRIPTION OF THE PREFERRED EMBODIMENTS

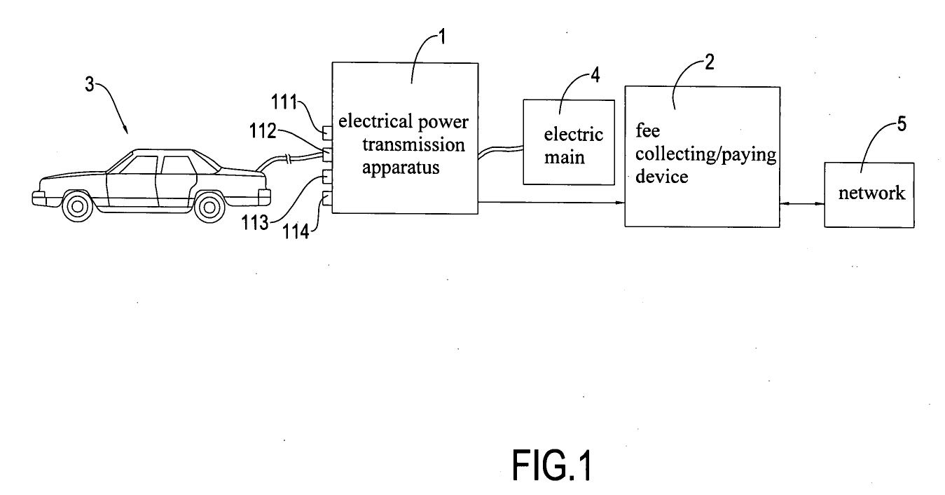

The present invention provides an electrical power transmission apparatus that functions to sell electrical power or to sell/buy electrical power. As shown in FIG. 1, the electrical power transmission apparatus 1 has a power supply source that is an electric main 4 in the embodiment illustrated. The electrical power transmission apparatus 1 comprises a first output port 111 and a second output port 112 for supplying and thus selling electrical power to a consumer who needs the electrical power, such as various electricity-operated machines 3, and may selectively comprise a first input port 113 and a second input port 114 for receiving and thus buying electrical power, such as accumulated power of a solar cell system, which can be sold to a power company or a government agency by the electrical power transmission apparatus 1 through a network-of the electric main 4.

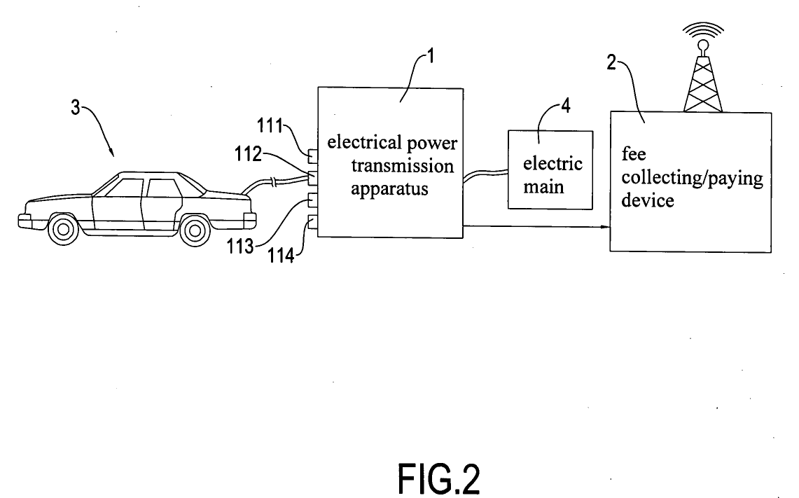

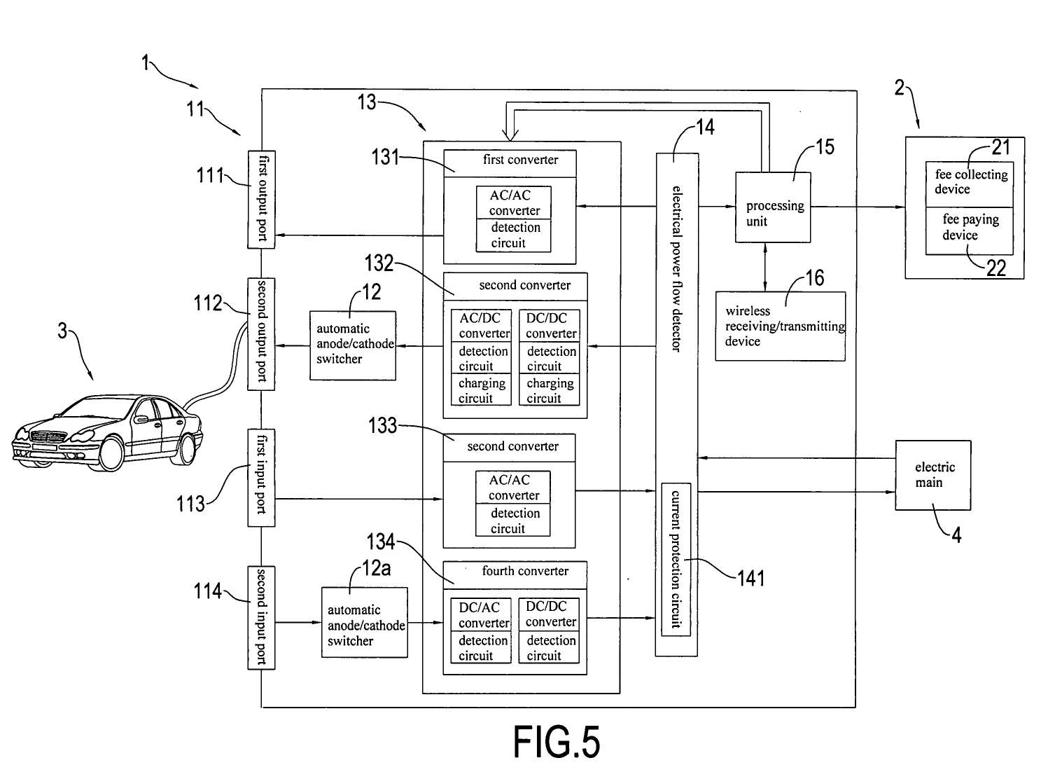

The electrical power transmission apparatus 1 is connected to a fee collecting/paying device 2 that carries out a fee collecting mechanism for selling of electrical power and a fee paying mechanism for buying of electrical power. The fee collecting/paying device 2 is connected to a network 5 for the operation of the fee collecting mechanism and the fee paying mechanism. Or alternatively, as shown in FIG. 2, the fee collecting/paying device 2 may provide the service of fee collecting mechanism and fee paying mechanism through an antenna 2. The fee collecting/paying device 2 is comprised of a fee collecting device 21 and a fee paying device 22, as shown in FIG. 5.

The electricity-operated machines 3 can be for example an electrical automobile, an electrical motorcycle, a lawn mower, a lawn removing machine, or an electrical saw and the example demonstrated in the drawings is an-electrical automobile.

It is apparent that the electrical power transmission apparatus 1 can operate to directly supply electrical power to a battery that is removed from those electricity-operated machines.

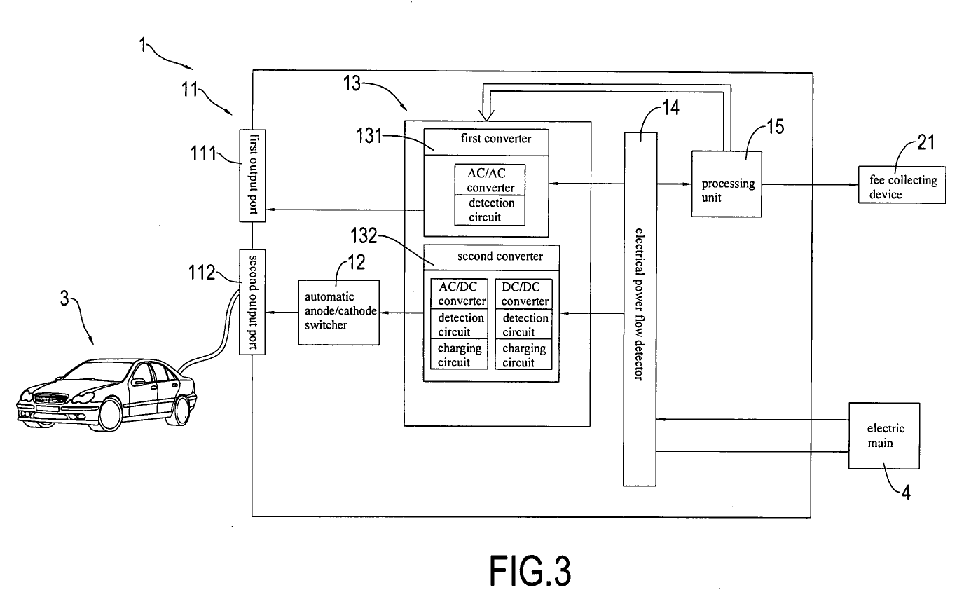

Referring to FIG. 3, which illustrates a block diagram of the electrical power transmission apparatus 1 in accordance with a first embodiment of the present invention that is only operable for selling electrical power, the electrical power transmission apparatus 1 comprises a transmission unit 11, a conversion unit 13, an electrical power flow detector 14, and a processing unit 15. The electrical power transmission apparatus 1 is electrically connected to the electric main 4 as an electrical power supply source and is externally connected to a fee collecting device 21.

The transmission unit 11 comprises a first output port 111 and a second output port 112. The electrical power flow detector 14 is electrically connected to the electric main 4 whereby the electrical power sold and/or bought can be detected by the electrical power flow detector 14.

The conversion unit 13 comprises a first converter 131 and a second converter 132 that effect conversion of electrical power (such as conversion of 10V into 220V, conversion of alternate current (AC) into direct current (DC), or conversion of direct current into alternate current). The first converter 131 is electrically connected between the first output port 111 and the electrical power flow detector 14, and the second converter 132 is electrically connected between the second output port 112 and the electrical power flow detector 14. The first and second output ports 111, 112 respectively supply AC power and DC power through the conversion effected by the first and second converters 131, 132.

The processing unit 15 is electrically connected between the electrical power flow detector 14 and the fee collecting device 21. The processing unit 15 is further electrically connected to the conversion unit 13 to control the selection of the electrical power to be transmitted to AC power or DC power. Further, the electrical power flow detected by the electrical power flow detector 14 is applied to the processing unit 15 for being converted to a related amount of fee with which the fee collecting device 21 may carry out a fee collecting operation.

The first converter 131 comprises an AC/AC converter (such as for conversion of 110V into 220V). The AC/AC converter comprises a detection circuit that detects the electrical current flowing through the AC/AC converter to be alternate current or direct current. The result of detection is applied to the processing unit 15 for processing. The second converter 132 comprises an AC/DC converter and a DC/DC converter. The AC/DC converter and the DC/DC converter both comprise a detection circuit and a charging circuit. The detection circuit of the AC/DC converter detects the electrical current flowing through the AC/DC converter to be alternate current or direct current with which the charging circuit of the AC/DC converter performs a charging operation. The result of detection is applied to the processing unit 15 for processing. The detection circuit of the DC/DC converter detects the electrical current flowing through the DC/DC converter to be alternate current or direct current with which the charging circuit of the DC/DC converter performs a charging operation. The result of detection is applied to the processing unit 15 for processing.

The fee collecting device 21 contains therein a fee collecting mechanism, which is operable with cash, a charge bill, or a payment card or a combination of any of the cash, a charge bill and a payment card.

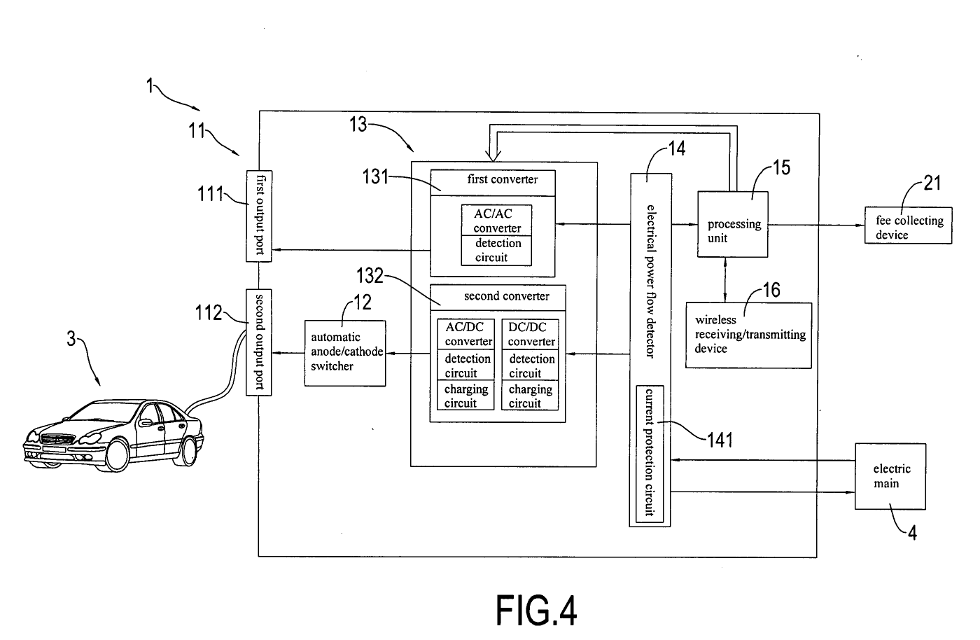

Referring to a second embodiment illustrated in FIG. 4, the electrical power transmission apparatus 1 may further comprise an automatic anode/cathode switcher 12 and a wireless receiving/transmitting device 16. The automatic anode/cathode switcher 12 is electrically connected between the second output port 112 and the second converter 132, whereby when a user makes a mistake of the polarity in connecting the anode/cathode, the automatic anode/cathode switcher 12 automatically switches the mistaken connection back to the correct connection. Apparently, any sort of suitable fool-proof device may be-alternatively or additionally incorporated to-ensure no mistaken connection of the polarity will be accidentally made by the user. The wireless receiving/transmitting device 16 is electrically connected to the processing unit 15, whereby when system abnormality (such as malfunction and insufficiency of cash) occurs in the processing unit 15 and/or a notification needs to be made, the wireless receiving/transmitting device 16 is operable to issue a warning and/or notification information. The wireless communication of the wireless receiving/transmitting device 16 can be done with for example a local area network (LAN), wireless fidelity (Wi-Fi), radio frequency (RF), and Blue-tooth. In addition, the electrical power flow detector 14 may contain a current protection circuit 141 for providing current protection.

Thus, the electrical power transmission apparatus 1 is capable to sell electrical power to an electricity-operated machine 3 of a consumer by employing the charging circuit of the second converter 132 to charge the electricity-operated machine 3. The electrical power flow of the charging operation is detected by the electrical power flow detector 14 and processed by the processing unit 15 to enable to fee collecting device 21 to perform fee collection. The consumer may pay the fee by means of cash, a charge bill, or a payment card.

Referring to FIG. 5, which shows a block diagram of a electrical power transmission apparatus 1 that is capable of both selling and buying electrical power in accordance with a third embodiment of the present invention, the difference between the third embodiment and the second embodiment is that a portion for buying electrical power is added, wherein the transmission unit 11 further comprise a first input port 113 and a second input port 114 and the conversion unit 13 further comprise a third converter 133 and a fourth converter 134 that effect conversion of electrical power (such as conversion of 110V into 220V, conversion of alternate current into direct current, or conversion of direct current into alternate current). Thus, the electrical power flow detector 14 is capable of detection of the electrical power bought. Further, the electrical power transmission apparatus 1 is connected to a fee paying device 22. The third converter 133 is electrically connected between the-first input port 113 and the electrical power flow-detector 14, and the fourth converter 134 is electrically connected between the second input port 114 and the electrical power flow detector 14. The first and second input ports 113, 114 respectively receive AC power and DC power through the conversion effected by the third and fourth converters 133, 134.

The third converter 133 comprises an AC/AC converter (such as for conversion of 220V into 110V). The AC/AC converter comprises a detection circuit that detects the electrical current flowing through the AC/AC converter to be alternate current or direct current. The result of detection is applied to the processing unit 15 for processing. The fourth converter 134 comprises a DC/AC converter and a DC/DC converter. The DC/AC converter and the DC/DC converter both comprise a detection circuit. The detection circuit of the DC/AC converter detects the electrical current flowing through the DC/AC converter to be alternate current or direct current and the result of detection is applied to the processing unit 15 for processing. The detection circuit of the DC/DC converter detects the electrical current flowing through the DC/DC converter to be alternate current or direct current and the result of detection is applied to the processing unit 15 for processing. Further, an automatic anode/cathode switcher 12a, which provides a similar function to that of the previously discussed automatic anode/cathode switcher 12, is electrically connected between the second input port 114 and the fourth converter 134. Apparently, any sort of suitable fool-proof device may be used in or alternatively or additionally incorporated into the automatic anode/cathode switcher 12a to ensure no mistaken connection of the polarity will be accidentally made by the user.

The fee paying device 22 contains therein a fee buying mechanism, which is operable with cash, a charge bill, or a value-storage card or a combination of any of cash, a charge bill and a value-storage card. Further, the fee paying device 22 and the fee collecting device 21 can be combined as a single fee collecting/paying device 2 as shown in FIGS. 1, 2, and 5.

Thus, besides selling electrical power to electricity-operated machines 3 used by general consumers, the electrical power transmission apparatus 1 is also capable of buying electrical-power by for example connecting accumulated electrical power of a solar cell system (not shown) to the second input port 114 to receive the electrical power and operating the electrical power flow detector 14 to detect the received electrical power flow, which is then processed by the processing unit 15 to activate the fee paying device 22 of the fee collecting/paying device 2 to effect payment, which can be done with for example cash, a charge bill, or a value-storage card.

The electrical power transmission apparatus in accordance with the present invention features that the electrical power transmission apparatus 1 is operated in substantially the same way as a gas station to sell electrical power from for example a electric main 4 to the general consumers, such as a driver of an electrical automobile or an electrical motorcycle or an owner of a lawn mower, a lawn removing device, or an electrical saw, or a person who brings a battery removed from such electrical machines, so as to provide electricity charging service with the same convenience as a gas station for extending the duration of operation period of all sorts of electricity-operated machines. The electrical power transmission apparatus 1 may function as a buying station that receives with proper payment external electrical power that is provided by a seller and sells the electrical power to a power company or a government agency, such as a seller transferring electrical power from a solar cell system to the electrical power transmission apparatus 1 for further transmission through the network of an electric main 4 to the power company or the government agency to realizing purchase of electrical power.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. An electrical power transmission apparatus adapted to connect between an electrical main and a fee collecting device, the electrical power transmission apparatus, comprising:
a transmission unit, which comprises a first output port and a second output port;
an electrical power flow detector, which functions to detect electrical power flow and is electrically connected-to the electric main;
a conversion unit, which comprises a first converter and a second converter that effect conversion of electrical power, the first converter being electrically connected between the first output port and the electrical power flow detector, the second converter being electrically connected between the second output port and the electrical power flow detector, the first and second output ports respectively supplying alternate-current (AC) power and direct-current (DC) power through the conversion effected by the first and second converters; and
a processing unit, which is electrically connected between the electrical power flow detector and the fee collecting device, the processing unit being further electrically connected to the conversion unit to control selection of the electrical power to be transmitted to AC power or DC power, the processing unit receiving a detection result of the electrical power flow detected by the electrical power flow detector for generating a related amount of fee with which the fee collecting device carries out a fee collecting operation.

2. The electrical power transmission apparatus as claimed in claim 1, wherein the first converter comprises an AC/AC converter, which comprises a detection circuit that detects an electrical current flowing through the AC/AC converter to be alternate current or direct current.

3. The electrical power transmission apparatus as claimed in claim 1, wherein the second converter comprises an AC/DC converter and a DC/DC converter, the AC/DC converter and the DC/DC converter both comprising a detection circuit and a charging circuit, one of the two detection circuits detecting an electrical current flowing through the AC/DC converter to be alternate current or direct current with which one of the two charging circuits performs a charging operation, the other one of the two detection circuits detecting an electrical current flowing through the DC/DC converter to be alternate current or direct current with which the other one of the two charging circuits performs a charging operation.

4. The electrical power transmission apparatus as claimed in claim 1 further comprising an automatic anode/cathode switcher, which is electrically connected between the second output port and the second converter.

5. The electrical power transmission apparatus as claimed in claim 1 further comprising a wireless receiving/transmitting device, which is electrically connected to the processing unit, whereby when the processing unit 15 generates system abnormality and a notification needs to be made, the wireless receiving/transmitting device is operable to issue a warning and/or notification information.

6. The electrical power transmission apparatus as claimed in claim 5, wherein the wireless receiving/transmitting device performs wireless communication by means of any one of a local area network (LAN), wireless fidelity (Wi-Fi), radio frequency (RF), and Blue-tooth.

7. The electrical power transmission apparatus as claimed in claim 1, wherein the fee collecting device contains therein a fee collecting mechanism, which is operable with cash, a charge bill, or a payment card.

8. The electrical power transmission apparatus as claimed in claim 1, wherein the fee collecting device contains therein a fee collecting mechanism, which is operable with a combination of cash, a charge bill and a payment card.

9. The electrical power transmission apparatus as claimed in claim 1, wherein the electrical power flow detector comprises a current protection circuit.

10. The electrical power transmission apparatus as claimed in claim 1, wherein the transmission unit comprises a first input port and a second input port and the conversion unit comprises a third converter and a fourth converter that effect conversion of electrical power, the third converter being electrically connected between the first input port and the electrical power flow detector, the fourth converter being electrically connected between the second input port and the electrical power flow detector, the first and second input ports respectively receiving AC power and DC power through the conversion effected by the third and fourth converters.

11. The electrical power transmission apparatus as claimed in claim 10, wherein the third converter comprises an AC/AC converter, which comprises a detection circuit that detects an electrical current flowing through the AC/AC converter to be alternate current or direct current.

12. The electrical power transmission apparatus as claimed in claim 10, wherein the fourth converter comprises a DC/AC converter and a DC/DC converter, the DC/AC converter and the DC/DC converter both comprising a detection circuit, one of the two detection circuits detecting an electrical current flowing through the DC/AC converter to be alternate current or direct current, the other one of the two detection circuits detecting an electrical current flowing through the DC/DC converter to be alternate current or direct current.

13. The electrical power transmission apparatus as claimed in claim 10 further comprising an automatic anode/cathode switcher, which is electrically connected between the second input port and the fourth converter.

14. The electrical power transmission apparatus as claimed in claim 10 further electrically connected to a fee paying device containing therein a fee buying mechanism, which is operable with cash, a charge bill, or a value-storage card.

15. The electrical power transmission apparatus as claimed in claim 14, wherein the fee paying device and the fee collecting device are combined as a single fee collecting/paying device.

16. The electrical power transmission apparatus as claimed in claim 10 further electrically connected to a fee paying device containing therein a fee buying mechanism, which is operable with a combination of cash, a charge bill, and a value-storage card.

17. The electrical power transmission apparatus as claimed in claim 16, wherein the fee paying device and the fee collecting device are combined as a single fee collecting/paying device.
